(19) United States
(12) Patent Application Publication
(10) Pub. No.: US 2019/0115653 A1
(43) Pub. Date: Apr. 18, 2019

(54) MOBILE TERMINAL

(71) Applicant: LG ELECTRONICS INC., Seoul (KR)

(72) Inventors: Changwon YUN, Seoul (KR); Dongjin KIM, Seoul (KR); Kangjae JUNG, Seoul (KR); Soyeon LEE, Seoul (KR); Sungjung RHO, Seoul (KR)

(73) Assignee: LG ELECTRONICS INC., Seoul (KR)

(21) Appl. No.: 15/952,167

(22) Filed: Apr. 12, 2018

(30) Foreign Application Priority Data
Oct. 12, 2017 (KR) 10-2017-0132562

(51) Int. Cl. H01Q 1/52; H01Q 1/24

(52) U.S. Cl. CPC H01Q 1/521; H01Q 1/38; H01Q 1/243

(57) ABSTRACT

A mobile terminal is provided that includes a body; a metal frame provided in the body and configured to support a display; a main board provided in a rear surface of the metal frame; a first conductive member arranged in a lateral surface of the body, spaced a preset distance apart from the metal frame, and configured to transceive a first frequency signal; a first connecting portion configured to connect one end of the first conductive member with the metal frame; a second conductive member arranged in a lateral surface of the body, spaced a preset distance apart from the metal frame and having one end which faces the other end of the first conductive member, and configured to transceive a second frequency signal; a slit formed between the other end of the first conductive member and one end of the second conductive member; a second connecting portion configured to connect the other end of the second conductive member with the metal frame; a first feeding line configured to supply power to the first conductive member; a second feeding line configured to supply power to the second conductive member; and a filter connected with the other end of the first conductive member and one end of the second conductive member.

### CROSS-REFERENCE TO RELATED APPLICATIONS

This application claims priority to Korean Patent Application No. 10-2017-0132562 filed on Oct. 12, 2017 in Korea, the entire contents of which is hereby incorporated by reference in its entirety.

### FIELD OF THE INVENTION

Embodiments of the present disclosure relate to a mobile terminal which includes a filter for enhancing isolation so as to reduce interference between neighboring antennas.

### DESCRIPTION OF THE RELATED ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

With the diversity of the functions, various wireless communication manners are applied to the mobile terminal to transceive data wirelessly. To utilize such diverse wireless communication manners, an antenna with different frequency properties are provided in the mobile terminal. To transceive more data, a plurality of antennas which is operable in one frequency band may be provided and data may be transceived simultaneously or sequentially.

In this instance, the wireless communication is affected by peripheral electronic components and causes mutual interference with them disadvantageously. Accordingly, there are ongoing studies and researches on the distance between the antenna and the other electronic components and the arrangement of the antenna.

### SUMMARY OF THE INVENTION

Accordingly, an object of the present invention is to address the above-noted and other problems. Embodiments of the present disclosure provide a mobile terminal which includes a filter for enhancing isolation so as to reduce interference between neighboring antennas.

Embodiments of the present disclosure may provide a mobile terminal comprising a body; a metal frame provided in the body and configured to support a display; a main board provided in a rear surface of the metal frame; a first conductive member arranged in a lateral surface of the body, spaced a preset distance apart from the metal frame, and configured to transceive a first frequency signal; a first connecting portion configured to connect one end of the first conductive member with the metal frame; a second conductive member arranged in a lateral surface of the body, spaced a preset distance apart from the metal frame and having one end which faces the other end of the first conductive member, and configured to transceive a second frequency signal; a slit formed between the other end of the first conductive member and one end of the second conductive member; a second connecting portion configured to connect the other end of the second conductive member with the metal frame; a first feeding line configured to supply power to the first conductive member; a second feeding line configured to supply power to the second conductive member; and a filter connected with the other end of the first conductive member and one end of the second conductive member.

The filter may comprise a first filter connected with the other end of the first conductive member and configured to allow the second frequency signal to pass through.

The first filter may comprise an inductor and a capacitor which are connected in parallel.

The first filter may further comprise an inductor connected in series.

The filter may comprise a second filter connected with one end of the second conductive member and configured to allow the first frequency signal to pass there through.

The second filter may comprise a capacitor.

The first conductive member may be arranged in a corner of the body in an L-shape.

The first conductive member and the second conductive member may be the MIMO antennas which are used in LTE communication.

According to the embodiments of the present disclosure, the mobile terminal in accordance with the present disclosure may include the filter arranged in the open end of the conductive member to block the flow of the current flowing between the neighboring antennas so that the isolation between the antennas may be improved.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure.

FIGS. 1B and 1C are conceptual views of one example of the mobile terminal, viewed from different directions;

FIG. 2 is a diagram illustrating an antenna structure of a conventional mobile terminal;

FIG. 3 is a graph illustrating characteristics of the antenna shown in FIG. 2;

FIG. 4 is a diagram illustrating an antenna structure of a mobile terminal in accordance with one embodiment of the present disclosure;

FIG. 5 is a graph illustrating characteristics of the antenna shown in FIG. 4;

FIG. 6 is a diagram illustrating an antenna structure of a mobile terminal in accordance with another embodiment of the present disclosure;

FIG. 7 is a conceptual diagram to describe a function of a filter provided in the antenna shown in FIG. 6; and

FIG. 8 is a graph illustrating characteristics of the antenna shown in FIG. 6.

### DESCRIPTION OF SPECIFIC EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

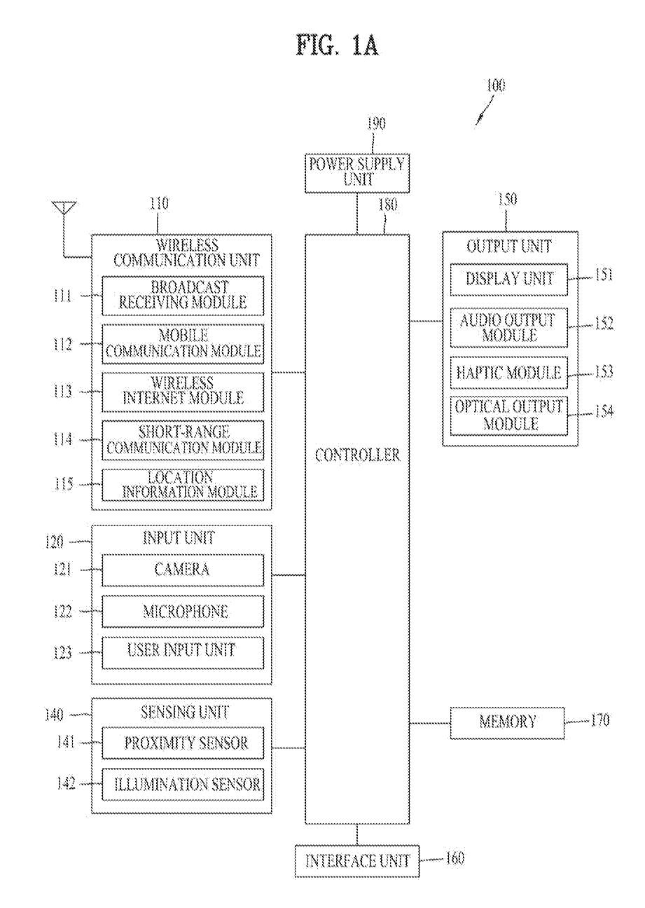

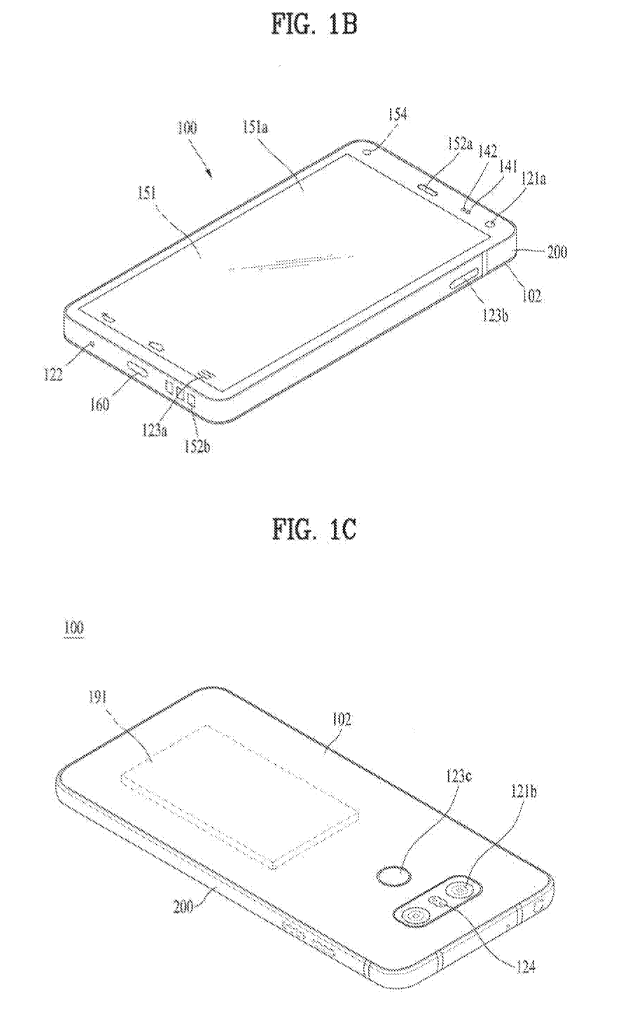

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in The FIG. 1A is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Hereinafter, the elements mentioned above will be described in detail referring to FIG. la, before describing various embodiments which are realized by the mobile terminal 100.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE) , LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 is configured to be applied an external power and an internal power by the control of the controller 180 and supply the electric power needed in operating the elements. The power supply unit 190 may include a battery. The battery may be an embedded type chargeable battery and detachably loaded in the frame for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to refer to the concept of this bore a mobile terminal (100) to at least one of the aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one metal frame may be additionally positioned between the front case 101 and the rear case 102.

The display 151 is disposed on a front surface of the terminal body to output information. As shown in the drawings, the window 151a of the display 151 is disposed to the front case 101 to form a front surface of the terminal body, together with the front case 101. As the mobile terminal 100 becomes minimized as a compact type, the front case may be omitted and only the window 151 may define the front surface of the mobile terminal.

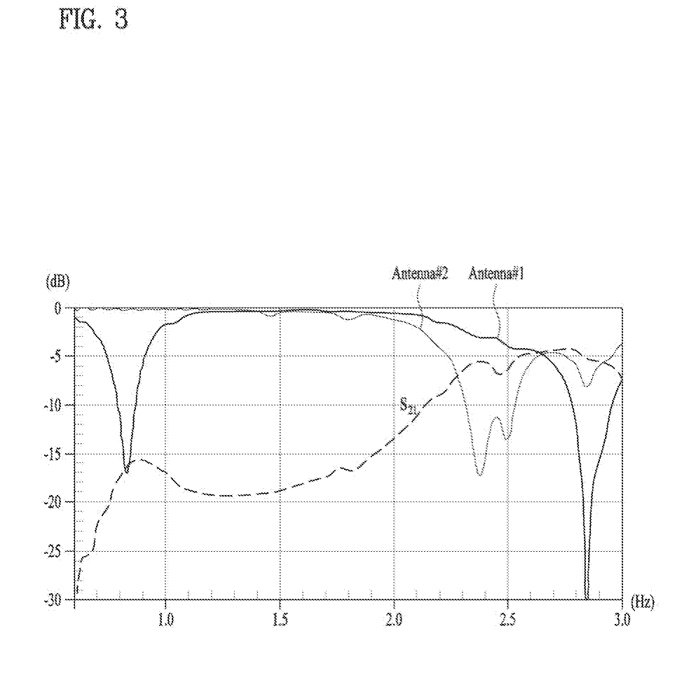

For the strength of the mobile terminal 100, the mobile terminal 100 may include a metal frame (290, see FIG. 3) which support a rear surface of the display 151. The metal frame 290 may include a metal material for the strength. Such the metal frame may be functioned to provide the strength to the mobile terminal and served as the ground with a large area including a conductive material, so that it may be connected with each of the components for the ground of the electronic components including an antenna.

The metal frame 290 may be provided not to be exposed outside or it may be integrally formed with a front case arranged in the front surface of the terminal body or a side case 200 arranged in a lateral surface of the body.

As the multimedia functions become expanded, the display 151 tends to be larger and the bezel located around the display 151 tends to be smaller. Especially, a predetermined space for locating the camera 121, the audio output unit 152, the proximity sensor 141 has to be secured in an upper end portion and a physical button has to be arranged in a lower end portion. Accordingly, the size expansion of the display 151 has to be limited.

However, the user input unit 123 capable of minimizing the number of the components and having a soft key, instead of the physical button, is realized. Only if necessary, the soft key is output on the screen. If not necessary, the soft key disappears and the screen may become larger.

When occasion occurs, electronic components may be loaded in the rear case 102. Examples of the electronic components loaded in the rear case 102 include a detachable battery, an identification module and a memory card. In this instance, a back cover for covering the electronic components loaded in the rear case 102 may be detachably coupled to the rear case 102. Accordingly, when the back cover 103 is detached from the rear case 102, the electronic components loaded in the rear case 102 are exposed outside.

Such the cases 101, 102 and 103 may be formed of synthetic resin by injection molding or metal, e.g., stainless steel (STS), aluminum (Al) and titanium (Ti).

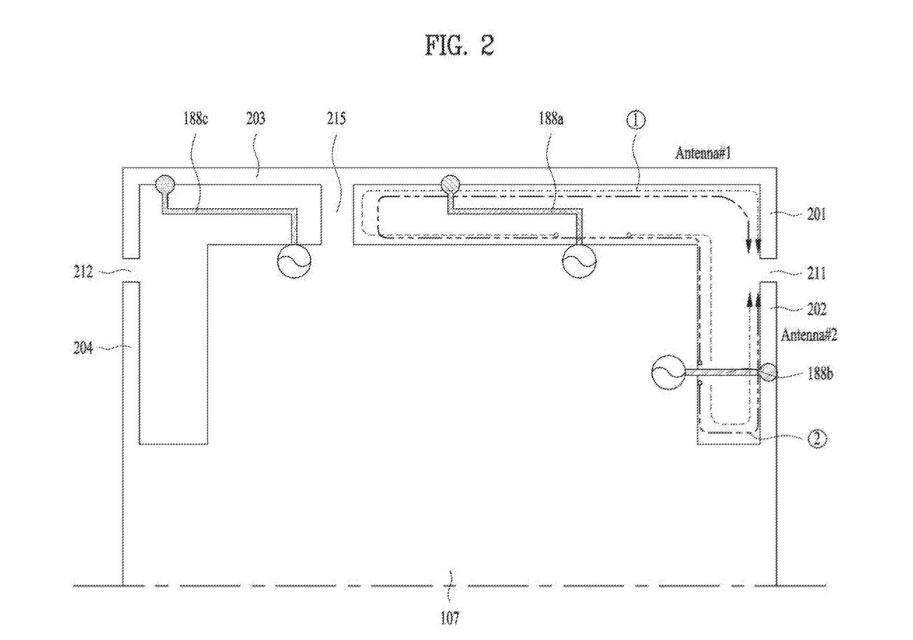

The mobile terminal 100 in accordance with the illustrated embodiment may include a side case 200 for surrounding a lateral surface. The side case 200 may include a metal material. For the wireless communication function, a predetermined area of the side case may include a non-metal material. As shown in FIGS. 1b and 1c, the side case 200 may include a plurality of conductive members (210, see FIG. 2) made of a conductive material such as metal; and a non-metal slit (220, see FIG. 3) arranged between the conductive members.

The mobile terminal 100 may be configured of one case which defines the internal space, different from the embodiment mentioned above configured of the plurality of the cases which define the internal space for accommodating the electronic components. In this instance, mobile terminal 100 may be realized as the uni-body having the synthetic resin or metal continued from the lateral surface to the rear surface.

Meanwhile, the mobile terminal 100 may include a waterproof unit (not shown) configured to prevent water from permeating into the terminal body. For example, the waterproof unit may be provided between the window 151a and the front case 101 or the front case 101 and the rear case 102 or the rear case 102 and the back cover 103 so as to seal the internal space once the cases are coupled to each other.

The mobile terminal 100 may further include the display 151, first and second audio output units 152a and 152b, a proximity sensor 141, an illuminance sensor 142, an optical output unit 154, first and second cameras 121a and 121b, first and second manipulation units 123a and 123b, a microphone 122 and an interface unit 160.

It will be described for the mobile terminal as shown in FIGS. 1B and 1C. The display unit 151, the first audio output module 151a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 151b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1A) may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Hereinafter, a control method which may be realized in the mobile terminal having the structure mentioned above and related embodiments will be described, referring to the accompanying drawings. As such, the present disclosure should be construed to extend to any alterations, equivalents and substitutes in addition to those which are particularly set out in the accompanying drawings.

As the multimedia function becomes important, the wireless communication technique performed in the mobile terminal may be diversified in various types including a short range wireless communication, remote range wireless communication or between devices wireless communication. The frequency bands used in the techniques is different from each other so that a different conductive member has to be used in each wireless communication technique.

Recently, the wireless communication techniques have been developing and MIMO (Multiple Input Multiple Output) technique configured to transceive signals in the same frequency band simultaneously or sequentially to support the large-capacity data is used. Two or more antennas are provided in the mobile terminal and two or more base stations are provided to transmit data via several passages and reception ends of the antennas are configured to detect the signals received from the passages so as to reduce interference and lower the transmission speeds of the signals. To apply such MIMO technique, the number of the conductive members provided in the limited size of the mobile terminal has to be increased.

The conductive member may form an electromagnetic field and exchange mutual effects with a peripheral conductive material. Accordingly, interference is generated between the conductive members arranged adjacent to each other only to cause the performance deterioration of the wireless signal. Accordingly, the conductive members may be attached to the case or the case is used as the conductive member to be arranged in the outer portion of the mobile terminal.

As the display becomes larger, the left and right bezel of the mobile terminal becomes almost zero (0) and the side case located in the right and left edge of the display can hardly function as the conductive member, so that the conductive member may be realized in upper and lower edge portions.

FIG. 2 is a diagram illustrating the antenna structure of the conventional mobile terminal 100. The metal frame 107 is located in the rear surface of the display 151 and compensates the strength of the thinner display 151. Electronic components such as a main board may be loaded in the rear surface of the metal frame 107. Also, the metal frame 107 is made of metal which is a conductive material and the area of the metal is wide so that the metal frame can serve as the ground.

The mobile terminal 100 mentioned above may perform wireless communication with an external terminal or a base station and use a signal at a different frequency for each wireless manner. Accordingly, a plurality of antennas corresponding to the frequency characteristics, respectively, may be provided. The antenna may transceive electromagnetic waves so as to affect or be affected by the other electronic components. Accordingly, the antennas may be arranged in an outer portion of the mobile terminal as possible to minimize the interference with the other electronic components or enhance signal transceiving efficiency with the external terminal or base station. A conductive pattern may be formed in an inner surface of the case. Alternatively, in case a predetermined portion of the case includes metal, the metal case may be used as the antenna.

When the side case 200 arranged around the lateral surface of the terminal body provided in the mobile terminal 100 is made of metal, a feeding line for applying power to the side case 200 is connected with the side case to realize the antennas. To realize the plurality of the antennas by using the side case 200, the side case 200 is divided into a plurality of conductive members 210, 202, 203 and 204. A slit 211 or 212 formed as a space between each two of the conductive members is filled with a non-conductive material so as to form the plurality of the conductive members.

Each of the conductive members 201, 202, 203 and 204 is connected with the metal frame 107 to be grounded or with the main board to be grounded. When the power is supplied to the conductive members 201, 202, 203 and 204 via feeding lines 188a, 188b and 188c, electric currents flow as shown in FIG. 2. The electromagnetic field is focused on the ends of the conductive members which are open, not grounded, so that the interference between the antennas (a first antenna and a second antenna) divided by the slits 211 might be generated.

FIG. 2 shows that a first conductive member 201 and a second conductive member 202 are arranged in opposite with respect to the slit. One end of the first conductive member 201 is connected with the metal frame 107 and the other end is open. One end of the second conductive member 202 faces the other end of the first conductive member 201, while forming the slit 211, and the other end is connected with the metal frame 107.

The first conductive member 201, the first feeding line 188a for supplying power to the first conductive member 201, the metal frame 107, a connecting portion 215 may form the first antenna. The second conductive member 202, the second feeding line for supplying power to the second conductive member 202, the metal frame 107 and the connecting between the second conductive member 202 and the metal frame 107 may form the second antenna.

A third conductive member and a fourth conductive member may be further provided and supplied power by a feeding line 188c to be used as the antennas. The first antenna and the second antenna realized by the first conductive member 201 and the second conductive member 202 are arranged in opposite, facing each other with respect to the slit, to generate interference with each other. However, the antennas realized by the third conductive member 203 and the fourth conductive member 204 may be separated from each other by the connecting portion 215, so as to generate little interference with each other. Accordingly, the object of the embodiment is to reduce the interference between the first antenna and the second antenna.

Basically, the first antenna and the second antenna have to be independently operated. However, as shown in FIG. 2, the flow (\hat{1}) of the currents supplied by the first feeding line 188a reaches not only the first conductive member 201 but also the second conductive member 202. The flow (\hat{2}) of the currents supplied by the second feeding line reaches the first conductive member 201. FIG. 3 is a graph illustrating the performance of the antennas shown in FIG. 2. In FIG. 3, a line refers a resonance frequencies of the first and second antennas (a point of a peak toward a negative value is a resonance frequency) and a dotted line refers isolation between the first antenna and the second antenna (as isolation has a negative value, the isolation becomes better).

The first antenna causes resonance a low frequency band from 0.7 to 0.8 GHz or less and a high frequency band of 2.7 GHz. The second antenna causes resonance from 2.3 to 2.5 GHz. In other words, the first antenna may transceive signals in LB (Low Band) and HB (High Band). The second antenna may transceive signals in MB (Mid Band).

The conductive members require a preset length or more allow the first antenna to transceive signals in a low frequency band so that the first conductive member may be formed in an L-shape to be arranged over two lateral surfaces. If the user holds right and left sides of the mobile terminal, the performance of the antenna might deteriorate. The portion used as the antenna may be provided in an upper end portion and a lower end portion of the mobile terminal. The first conductive member is arranged in the upper or lower corner or edge and the second conductive member is arranged in a lateral surface adjacent to the upper or lower edge.

The isolation between the first antenna and the second antenna is bad in the Mid Band and the High Band. To solve that, the mobile terminal includes a filter 221 and 222 for passing only a specific frequency signal or blocking. The filter may be realized on the main board and have one end which is connected with the conductive member and the other end which is grounded.

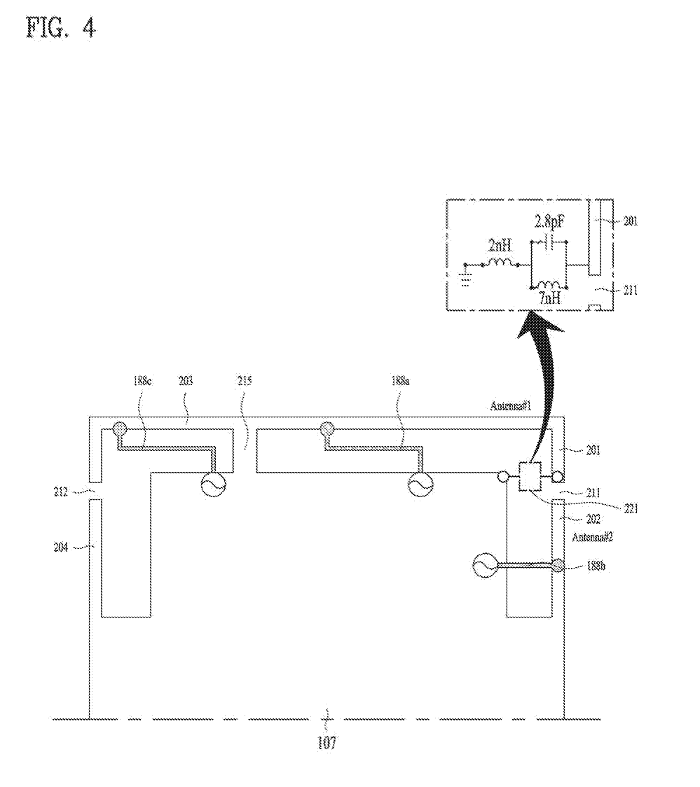

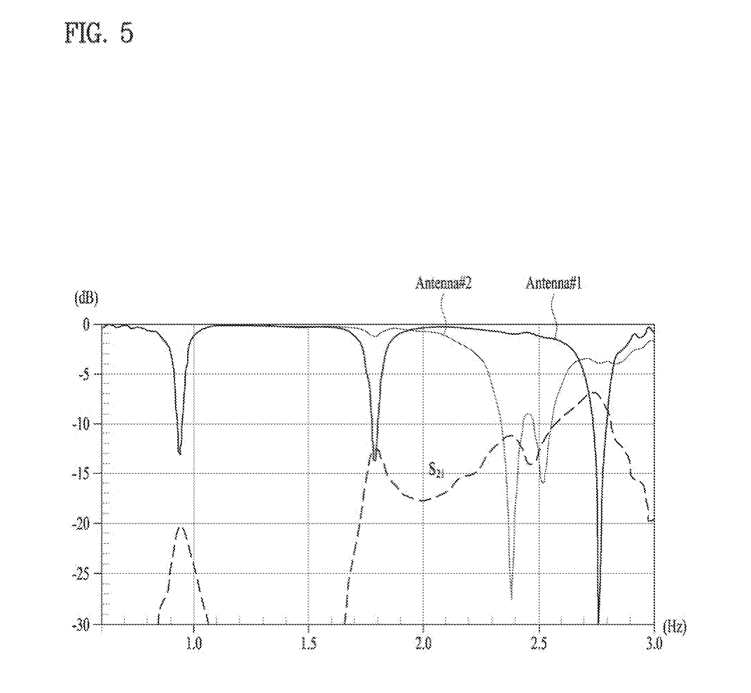

FIG. 4 is a diagram illustrating an antenna structure of a mobile terminal 100 in accordance with one embodiment of the present disclosure and FIG. 5 is a graph illustrating characteristics of the antenna shown in FIG. 4. A first filter 221 is provided in the other end of the antenna which is open. The intensity of the electromagnetic wave is the strongest at the other open end of the first antenna and the other open end of the first antenna is located closest to the second antenna. Accordingly, it is effective to improve the isolation to connect the first filter 221 with the other end of the first conductive member 201.

The filter allows a signal at a corresponding frequency to the resonance frequency of the second antenna to pass there through and a signal at a corresponding frequency to the resonance frequency of the first antenna not to pass there through. The resonance frequency of the second antenna is in the Mid Band and the first filter 221 may be a bandpass filter.

The currents supplied by the second feeding line may pass through the filter to block the influence of the second antenna on the first antenna, not flowing the first antennal. Referring to FIG. 5, a value of a dotted line graph (S21) becomes low in the Mid Band (2.3 GHz) and the isolation gets enhanced, compared with the graph of FIG. 3.

The first filter shown in FIG. 4 may include a capacitor and an inductor which are connected in parallel. Only the signals in the resonance frequency band of the second antenna are adjusted to pass by adjusting values of the capacitor and the inductor. During the tuning process, an inductor may be added in series if necessary.

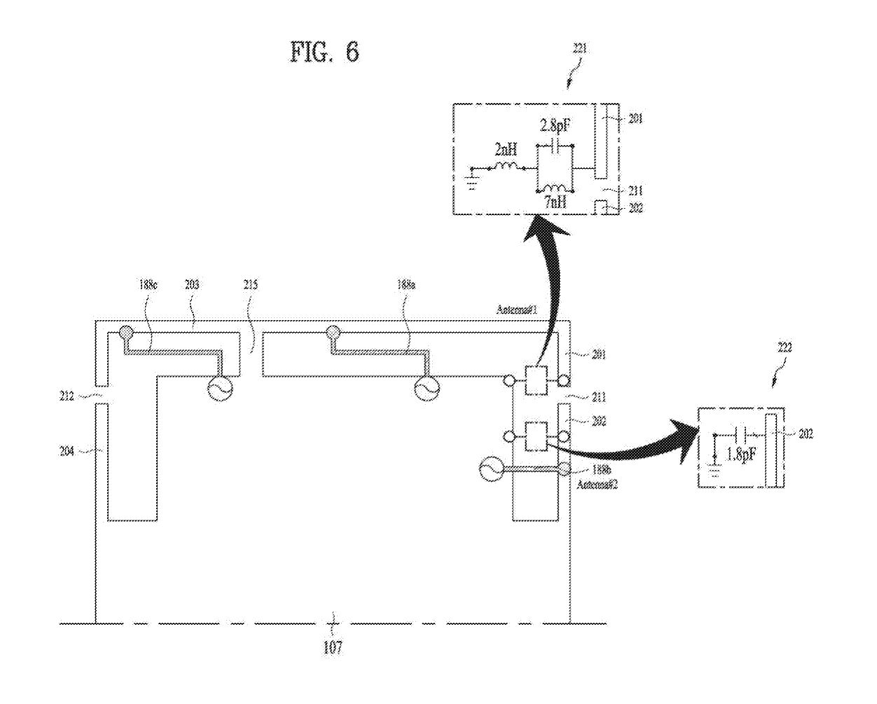

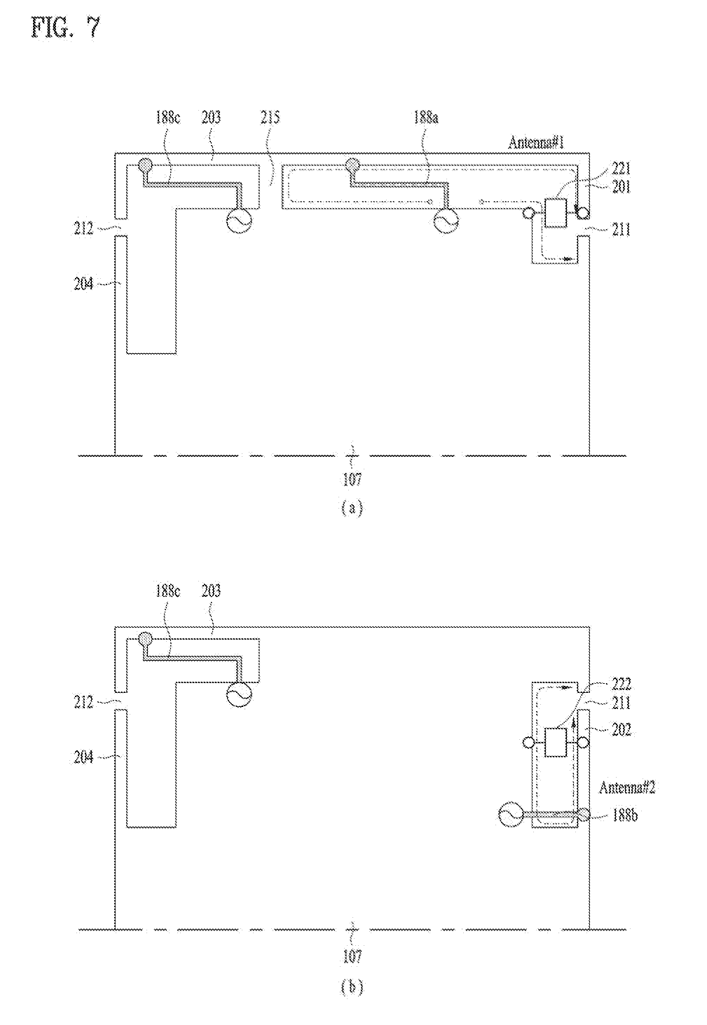

FIG. 6 is a diagram illustrating an antenna structure of a mobile terminal 100 in accordance with another embodiment of the present disclosure and FIG. 7 is a conceptual diagram to describe a function of a filter provided in the antenna shown in FIG. 6. The mobile terminal 100 in accordance with the illustrated embodiment may include a second filter 222 provided in open one end of the second conductive member 202. The second filter allows a high frequency band signal corresponding to the resonance frequency of the first antenna to pass there through so as to block the currents supplied to the first antennal from flowing to the second antenna.

Referring to FIG. 3, the first antenna causes resonance in the high frequency band and the low frequency band but the isolation between the first antenna and the second antenna is low in the high frequency band. Accordingly, the second filter 222 may be a high-pass filter which allows a high frequency signal to pass there through. The high pass filter may include a capacitor as shown in FIG. 6. The resonances of the first and second antennas may be tuned by adjusting a value of the capacitor. The second filter 222 may be realized by using an inductor rather than the capacitor.

FIG. 7 (a) is a diagram illustrating the flow of the currents supplied by the first feeding line 188a. The high frequency signal supplied by the first feeding line 188a may pass through the second filter 222 and the flow of the currents substantially looks like flow without the second conductive member 202. FIG. 7 (b) is a diagram illustrating the flow of the currents supplied by the second feeding line. The mid frequency signal supplied by the second feeding line may pass through the first filter 221 and the flow of the currents substantially looks like flow without the first conductive member 201.

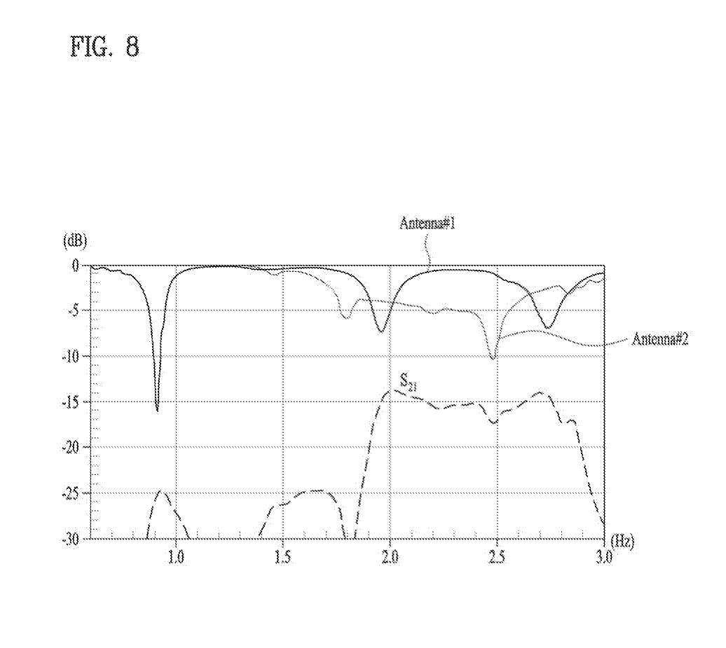

Referring to FIG. 8, the isolation (S210) is enhanced in both the Mid Band and the High Band so as to minimize the interference between the first antenna and the second antenna.

As mentioned above, the mobile terminal in accordance with the present disclosure includes the filter arranged in the open end of the conductive member to block the flow of the current flowing between the neighboring antennas so that the isolation between the antennas may be improved.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A mobile terminal comprising:
a body;
a metal frame on the body and configured to support a display;
a main board on a rear surface of the metal frame;
a first conductive member on a lateral surface of the body, the first conductive member spaced a preset distance apart from the metal frame and configured to transceive a first frequency signal;
a first connecting portion configured to connect a first end of the first conductive member to the metal frame;
a second conductive member on a lateral surface of the body, the second conductive member spaced a preset distance from the metal frame, having a first end facing a second end of the first conductive member and configured to transceive a second frequency signal;
a slit formed between the second end of the first conductive member and the first end of the second conductive member;
a second connecting portion a second end of the second conductive member to the metal frame;
a first feeding line configured to supply power to the first conductive member;
a second feeding line configured to supply power to the second conductive member; and
a first filter connected with the second end of the first conductive member and the first end of the second conductive member.

2. The mobile terminal of claim 1, wherein the first filter is configured to allow the second frequency signal to pass.

3. The mobile terminal of claim 1, wherein the first filter comprises an inductor and a capacitor connected in parallel.

4. The mobile terminal of claim 3, wherein the first filter further comprises an inductor and a capacitor connected in series with the inductor and a capacitor connected in parallel.

5. The mobile terminal of claim 1, further comprising a second filter connected to the first end of the second conductive member and configured to pass the first frequency signal.

6. The mobile terminal of claim 5, wherein the second filter comprises a capacitor.

7. The mobile terminal of claim 1, wherein the first conductive member has an L-shape and is located in a corner of the body.

8. The mobile terminal of claim 1, wherein the first conductive member and the second conductive member are Multiple Input Multiple Output (MIMO) antennas used in LTE communication.
